(19) United States
(12) Patent Application Publication
(10) Pub. No.: US 2026/0054482 A1
(43) Pub. Date: Feb. 26, 2026

(54) Stabilized Fluid Ejection Head

(71) Applicant: Brady Worldwide, Inc., Milwaukee, WI (US)

(72) Inventor: Bruce D. Gibson, Lexington, KY (US)

(21) Appl. No.: 19/373,036

(22) Filed: Oct. 29, 2025

Related U.S. Application Data
(63) Continuation-in-part of application No. 18/409,877, filed on Jan. 11, 2024.
(60) Provisional application No. 63/713,252, filed on Oct. 29, 2024.

(51) Int. Cl. B41J 2/14; B41J 2/16

(52) U.S. Cl. CPC B41J 2/1404; B41J 2/14145; B41J 2/14201; B41J 2/1433; B41J 2/1601; B41J 2/1607; B41J 2/1626; B41J 2002/14403; B41J 2002/14419

(57) ABSTRACT

A fluid ejection head including a semiconductor substrate containing a plurality of fluid ejectors thereon and a fluid supply via etched therethrough. A flow feature layer is attached to the semiconductor substrate, the flow feature layer containing a plurality of fluid channels and fluid chambers for the fluid ejectors, wherein the fluid channels are configured to provide fluid from the fluid supply via through the fluid channels to the fluid chambers for ejection of fluid through fluid nozzles associated with the fluid chambers, and wherein each of the fluid channels have an inlet channel and expansion channel. A filter pillar is provided in each inlet channel, the filter pillar having a taper angle ranging from about 25 to about 35 degrees relative to planes defined by parallel sides of the filter pillar. A nozzle plate containing the fluid nozzles is attached to the flow feature layer.

### CROSS-REFERENCE TO RELATED APPLICATIONS

This application is a continuation-in-part of application Ser. No. 18/409,877, filed Jan. 11, 2024, now pending, the entirety of which is hereby incorporated by reference.

This application claims priority under 35 U.S.C. § 119 to U.S. Provisional Application No. 63/713,252, filed on Oct. 29, 2024, the entirety of which is hereby incorporated by reference.

### TECHNICAL FIELD

The disclosure is related to fluid ejection heads and in particular to a fluid ejection head capable of stabilizing performance and extending high frequency fluid ejection operation.

### BACKGROUND AND SUMMARY

The frequency response of a fluid ejector is limited by the behavior of the fluid as it is ejected from the fluid ejection chamber and the flow of fluid through a channel to refill the fluid ejection chamber. Fluid ejection heads that are capable of ejecting relatively large droplets or volumes of fluid can be especially challenging due to air entrainment in the fluid refill channel to the fluid ejection chamber. The fluid meniscus in a large fluid ejection nozzle is not able to hold its shape compared to the fluid meniscus for a smaller fluid ejection nozzle and can deform during firing transients causing air to be ingested and possibly trapped in the fluid ejection chamber. The result is unstable droplet size, velocity, and trajectory and ultimately degraded droplet quality. Accordingly, what is needed is an ejection head designed to overcome air ingestion and air trapping issues in order to greatly improve droplet performance and droplet quality.

In view of the foregoing, an embodiment of the disclosure provides a fluid ejection head including a semiconductor substrate containing a plurality of fluid ejectors thereon and a fluid supply via etched therethrough. A flow feature layer is attached to the semiconductor substrate, wherein the flow feature layer contains a plurality of fluid channels and fluid chambers for the plurality of fluid ejectors, wherein the plurality of fluid channels are configured to provide fluid from the fluid supply via through the plurality of fluid channels to the fluid chambers for ejection of fluid through fluid nozzles associated with the fluid chambers, and wherein each of the plurality of fluid channels have an inlet channel and expansion channel. A filter pillar is provided in each inlet channel, wherein the filter pillar has a taper angle ranging from about 25 to about 35 degrees relative to planes defined by parallel sides of the filter pillar. A nozzle plate containing the fluid nozzles is attached to the flow feature layer.

Another embodiment provides a method for reducing the air entrapment in a fluid ejection head. The method includes providing a semiconductor substrate containing a plurality of fluid ejectors thereon and a fluid supply via etched therethrough. A flow feature layer is attached to the semiconductor substrate, wherein the flow feature layer contains a plurality of fluid channels and fluid chambers for the plurality of fluid ejectors, wherein the plurality of fluid channels are configured to provide fluid from the fluid supply via through the fluid channels to the fluid chambers for ejection of fluid through fluid nozzles associated with the fluid chambers. Inlet channels and expansion channels are formed between the fluid supply via and each of the fluid chambers of the flow feature layer. A filter pillar is formed in each of the inlet channels, wherein each of filter pillar has a taper angle ranging from about 25 to about 35 degrees relative to planes defined by parallel sides of the filter pillar. A nozzle plate is attached to the flow feature layer. Fluid is fed from a fluid cartridge to the fluid ejection head and fluid is ejected from the fluid ejection head.

Another embodiment provides a fluid dispensing device for ejecting an aqueous fluid having a viscosity ranging from about 2 to about 5 millipascal second at 23° C. The fluid dispensing device includes a fluid ejection head attached to a fluid supply cartridge containing the fluid, wherein the fluid ejection head contains a semiconductor substrate containing a plurality of fluid ejectors thereon and a fluid supply via etched therethrough. A flow feature layer is attached to the semiconductor substrate, wherein the flow feature layer has a plurality of fluid channels and fluid chambers for the plurality of fluid ejectors, wherein the fluid channels are configured to provide the fluid from the fluid supply via through the fluid channels to the fluid chambers for ejection of the fluid through fluid nozzles associated with the fluid chambers, and wherein the fluid channels include inlet channels and expansion channels. A filter pillar is disposed in each inlet channel, wherein the filter pillar has a taper angle ranging from about 25 to about 35 degrees relative to planes defined by parallel sides of the filter pillar. A nozzle plate containing the fluid nozzles is attached to the flow feature layer. The expansion channels have an expansion channel width (W_{E}) to inlet channel width (W_{I}) ratio (W_{E}/W_{I}) ranging from about 3 to about 4.

In some embodiments, the elongated filter pillar has a taper angle of about 30 degrees relative to planes defined by parallel sides of the filter pillar.

In some embodiments, the expansion channels are disposed between each of the inlet channels and associated fluid chambers.

In some embodiments, the expansion channels have an expansion channel width (W_{E}) to inlet channel width (W_{I}) ratio (W_{E}/W_{I}) ranging from about 3 to about 4. In other embodiments, the expansion channels have an expansion channel length (L_{E})=((W_{E}/W_{I})−1)/2*W_{I}*1/tan(30), wherein L_{E}/W_{I}=((W_{E}/W_{I})−1)/(2*1/tan(30)). In still other embodiments, L_{E}/W_{I} ranges from about 1.5 to about 4.0.

In some embodiments, W_{E}/W_{I} is greater than 1.5 and L_{E}/W_{I} is greater than 1.5.

In some embodiments, there is provided a fluid cartridge having fluid to be dispensed by the fluid ejection head of claim 1.

In some embodiments, the fluid ejection head is configured to reduce fluid velocity at a centerline the fluid chambers.

Advantages of the disclosed embodiments include, but are not limited to providing a reduction in peak flow velocity that reduces the refilling fluid impact on the retracted nozzle meniscus. The lower peak velocity of the disclosed fluid ejection head also reduces air entrainment when the meniscus is retracted. Because the meniscus is more stable with the disclosed fluid ejection head, a higher fluid ejection frequency is provided. Also, lower viscosity fluids can be used due to the improved fluid ejection stability provided by the disclosed fluid ejection head design. The elongated filter pillar in the disclosed fluid ejection head improves performance by eliminating or reducing stagnate fluid refill zones in the fluid refill channel.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is top plan view, not to scale, of a prior art fluid ejection head showing features thereof.

FIG. 2 is a perspective view of a fluid cartridge for use with a fluid ejection head according to an embodiment of the disclosure.

FIG. 3 is a perspective view, not to scale, of a fluid dispensing device for dispensing fluid using the fluid cartridge of FIG. 2.

FIG. 4 is a top plan view, not to scale, of a prior art fluid ejection head.

FIG. 5 is a top plan view illustrating a fluid flow profile in a modified prior art ejection head having a prior art filter pillar.

FIG. 6 is a plan top view, not to scale, of a modified fluid ejection head according to an embodiment of the disclosure.

FIG. 7 is a graphical comparison of the fluid flow rates versus distance from the centerline of a fluid chambers for the prior art fluid ejection head of FIG. 4 and for the modified fluid ejection head of FIG. 6.

FIG. 8. is a to plan view illustrating a fluid flow profile in the modified ejection head of FIG. 6.

FIG. 9 is a vertical line print example using the modified prior art ejection head of FIG. 5.

FIG. 10 is a vertical line print example using the modified fluid ejection head of FIG. 6.

### DEFINITIONS AND TEST METHODS

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

The terms “comprising,” “including,” “having,” and their derivatives, are not intended to exclude the presence of any additional component, step, or procedure, whether or not the same is specifically disclosed. In order to avoid any doubt, all articles claimed through use of the term “comprising” may include any additional component, feature, or element, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa. As used herein, “a,” “an,” “the,” “at least one,” and “one or more” are used interchangeably.

A “polygon” is a closed-plane figure bounded by at least three sides. The polygon can be a regular polygon, or an irregular polygon having three, four, five, six, seven, eight, nine, ten, or more sides. Nonlimiting examples of polygonal shapes include triangle, square, rectangle, diamond, trapezoid, parallelogram, hexagon, and octagon.

Viscosity of the aqueous fluid is measured at 23° C. in accordance with the rectangular slit method using a Viscoliner vibrating bulb instrument.

### DETAILED DESCRIPTION OF EMBODIMENTS

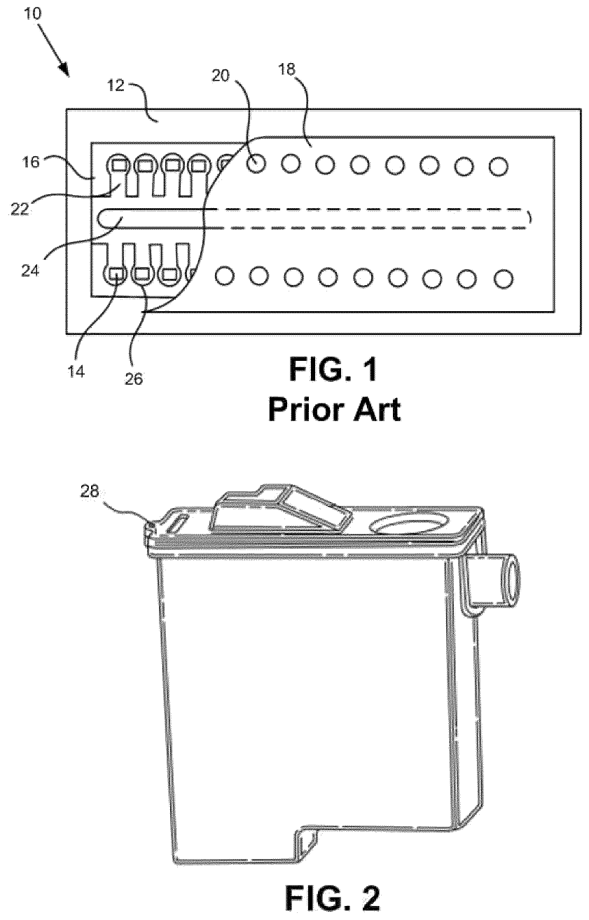

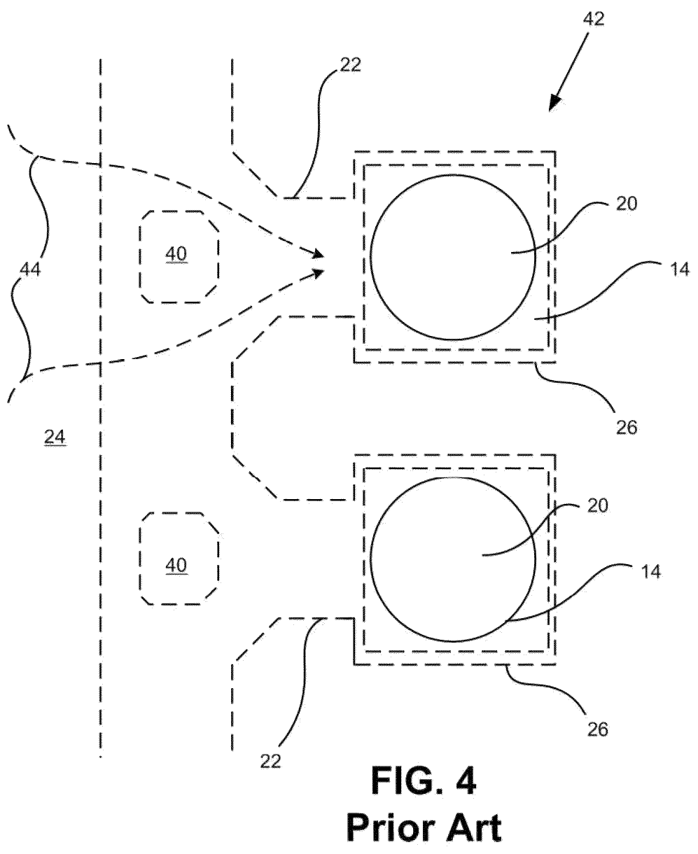

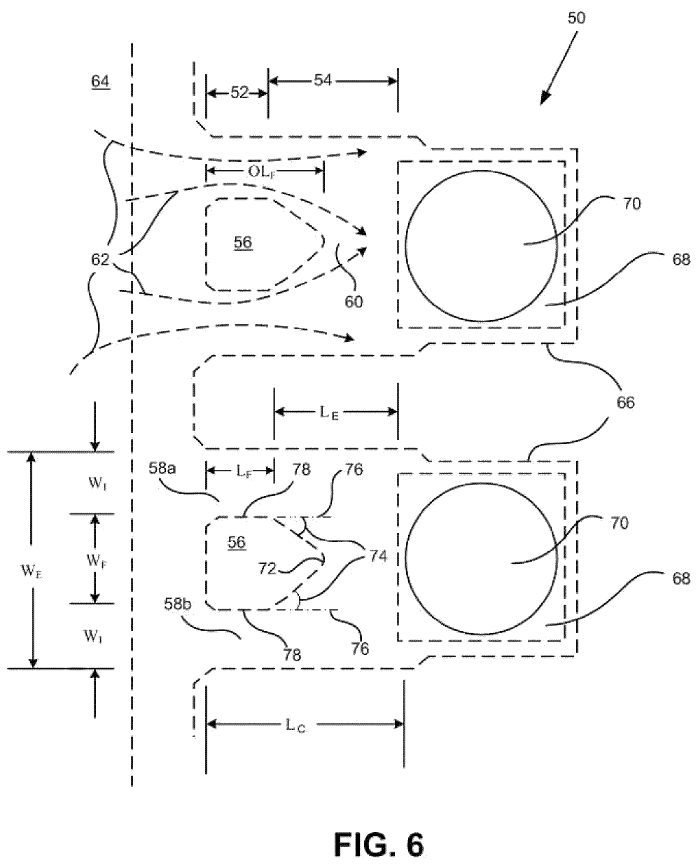

Fluid ejection heads are used in a variety of applications that may involve the ejection of aqueous and non-aqueous fluids. Atypical ejection head 10 is illustrated in FIG. 1 and includes a semiconductor substrate 12, having a plurality of fluid ejectors 14 formed thereon, a flow feature layer 16 attached to the semiconductor substrate 12, and a nozzle plate 18 containing fluid nozzles 20 (also referred to herein as nozzle holes) therein attached to the flow feature layer 16. The flow feature layer 16 includes fluid channels 22 leading from a fluid supply via 24 etched through the semiconductor substrate 12 to provide a flow of fluid through the fluid channels 22 to fluid chambers 26 containing the fluid ejectors 14. In some embodiments, the fluid channels 22 also contain filter pillars to filter the fluid before it enters the fluid chambers 26, as described below with respect to prior art fluid ejection head 42 (see FIG. 4) and modified fluid ejection head 50 (see FIG. 6). Returning to FIG. 1, the flow feature layer 16 may have a thickness ranging from about 5 to about 50 microns (μm). The semiconductor substrate 12 is preferably a silicon semiconductor substrate containing the plurality of fluid ejectors 14 formed thereon. The fluid ejectors 14 may be selected from piezoelectric devices or heater resistors formed on the semiconductor substrate 12. Fluid supplied through the fluid supply via 24 in the semiconductor substrate 12 flows through the fluid channels 22 to a fluid chambers 26 formed in the flow feature layer 16 where the fluid is caused to be ejected through fluid nozzles 20 in the nozzle plate 18 when the fluid ejectors 14 are activated. The nozzle plate 18 may have a thickness ranging from about 5 to about 50 μm.

The fluid channels 22 leading from the fluid supply via 24 and into the fluid chambers 26 provide the needed damping to properly refill the fluid chambers 26 after firing the fluid ejectors 14. The damping is set to ensure that the fluid ejection head is stable and provides a consistent performance. The damping also limits the refill time and subsequent jetting frequency limit.

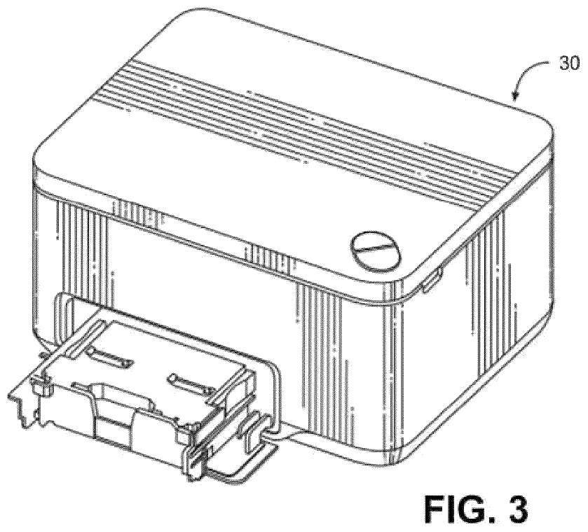

Fluid to be ejected by the ejection head 10 is provided through the fluid supply via 24 from a fluid filled cartridge 28 (FIG. 2) to which the ejection head 10 is attached. Control of fluid ejection is provided by a fluid dispensing device 30 (FIG. 3) to which the fluid filled cartridge 28 is attached. The fluid dispensing device 30 may be a printer or other fluid deposition device that may be used to eject a variety of aqueous and/or non-aqueous fluids having a range of fluid viscosities.

For some applications, the droplet size of fluid to be dispensed may range from about 30 to about 60 picoliters (pL), such as from about 45 to about 55 pL. For aqueous fluid dispensing applications, the nozzle holes 20 for dispensing droplet sizes ranging from about 30 to about 60 pL may have a diameter ranging from about 30 to about 40 μm. Subsequent to ejecting fluid from the fluid chambers 26, fluid must flow into the fluid chambers 26 for the next fluid ejection cycle. A retracted meniscus is formed in the nozzle holes 20 after fluid ejection which causes the fluid chamber 26 to being refilled. As the nozzle hole size increases, the meniscus pressure decreases according to the following:

∝1/R Meniscus pressure

wherein R is the radius of the retracted meniscus. The decrease in pressure with a larger nozzle hole size means that the shape of meniscus can be disrupted more easily by fluid flowing into the fluid chambers 26. Accordingly, as the meniscus pressure decreases, the fluid flowing into the fluid chambers 26 has a tendency to deform the meniscus due to an increase in fluid flow velocity at centerlines of the fluid channels 22, which in turn increases the amount of air that may be entrained in the fluid from the deformed meniscus in the nozzle holes 20. FIG. 4 shows a top plan view of a prior art fluid ejection head 42 in which the fluid channels 22 contain blunt filter pillars 40 to filter the refill fluid 44 before it enters the fluid chambers 26. When the refill fluid 44 flows through the prior art fluid ejection head 42, the refill fluid 44 creates high centerline flow velocity in the fluid channels 22, which adversely impacts the retracted meniscus in the nozzle holes 20.

In order to decrease the fluid velocity at a centerline of the fluid channel, a modified fluid ejection head 50, shown in a top plan view in FIG. 6, is provided having an inlet channel 52, a fluid expansion channel 54, and a filter pillar 56. The filter pillar 56 is a tapered filter pillar. The geometry of the modified fluid ejection head 50 provides two channels of flow 58a and 58b that impact the meniscus with a more diffuse flow profile, thereby reducing the low flow or no flow dead space 60 where entrapped air can accumulate.

The modified fluid ejection head 50 includes the inlet channel 52 that provides refill fluid 62 from the fluid supply via 64 to refill the fluid chamber 66 after activating the fluid ejector 68 that causes the fluid 62 to be expelled through the nozzle hole 70.

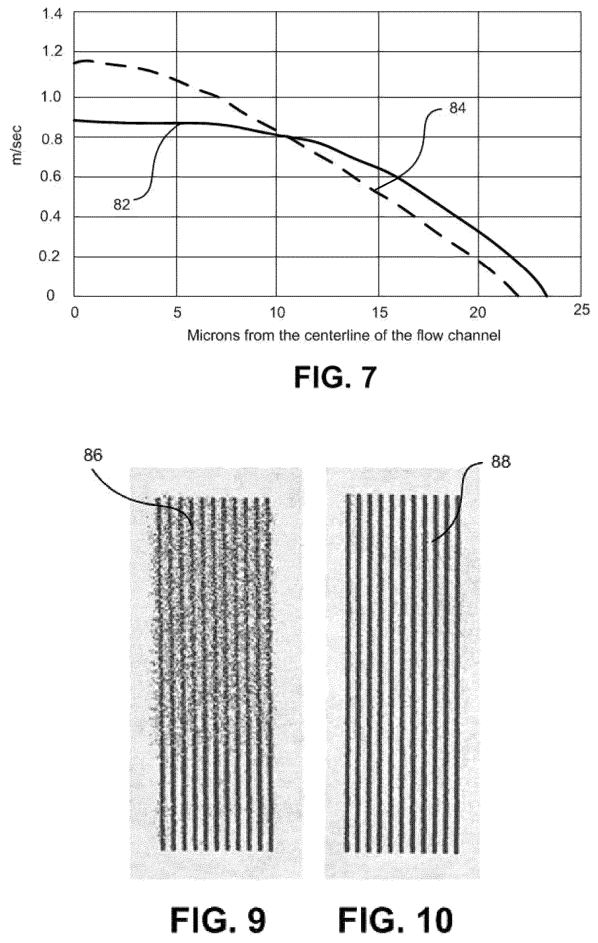

An important feature of the modified fluid ejection head 50 is the tapered filter pillar 56 having an elongated portion 72 of the filter pillar 56 that forms an angle 74 ranging from about 25 to about 35 degrees relative to a plane 76 defined by parallel sides 78 of the filter pillar 56. In some embodiments, the angle 74 is about 30 degrees. The tapered filter pillar 56 may have a width (W_{F}) ranging from about 20 to 25 μm, a length to taper (L_{F}) of about 10 to about 15 μm, and an overall length (OL_{F}) ranging from about 25 to about 30 μm. The height of the filter pillar 56 may be the same as the height of the fluid channels 58a and 58b and may range from about 25 to about 35 μm. The tapered filter pillar 56 acts to block debris and to divide the fluid refill flow into the two parallel fluid flow paths 62. A unique feature of the filter pillar 56 is its significantly tapered shape on the fluid chamber side 66 thereof. The taper of the filter pillar 56 does not significantly impact refill time, but rather reduces the amount of air that is lodged in a stagnant flow location of the fluid channel adjacent to the filter pillar 56. The angle 74 of the elongated portion 72 is set high enough to not significantly change the flow expansion angle during refill. Accordingly, the tapered filter pillar 56 does not adversely affect refill resistance and frequency response. The shape of the tapered filter pillar 56 of the modified fluid ejection head 50 provides two channels of fluid flow 58a, 58b that impact the meniscus with a more diffuse flow profile and lower maximum fluid velocity at the centerline of the fluid chambers 66, as shown in FIG. 7 (line 82) than the maximum fluid velocity at the centerlines of the fluid chambers 26 of the prior art ejection head 42 (line 84).

The filter pillar 56 has a cross-sectional shape. In some embodiments, the cross-sectional shape of the filter pillar 56 is a polygon, or further, a polygon having five sides, as shown in FIG. 6. Two of the sides are parallel sides 78. Parallel sides are two sides in the same plane that are always the same distant apart and never intersect. In some embodiments, the parallel sides 78 have a proximal end and a distal end, the distal end terminating at the elongated portion 72 of the filter pillar 56. In the embodiment shown in FIG. 6, one side of the filter pillar 56 connects the proximal ends of each of the parallel sides 78, said side extending perpendicular to each of the parallel sides 78. The elongated portion 72 is formed from two conjoining sides that begin at the distal end of a parallel side 78 and extend at the angle 74 towards one another to terminate at an intersection point. The intersection point of the two sides that form the elongated portion 72 may be an angled point or a curved point. In some embodiments, the elongated portion 72 has a triangular, or a substantially triangular cross-sectional shape, as shown in FIG. 6.

In some embodiments, the elongated portion 72 of the filter pillar 56 comes to a point or has a radius that is 10 μm or less, or 6 μm or less. In an embodiment, the elongated portion 72 is formed from two conjoining sides that begin at the distal end of a parallel side 78 and extend at the angle 74 towards one another to terminate at an intersection point. The intersection point of the two sides that form the elongated portion 72 may be an angled point or a curved point. The intersection point of the two sides that form the elongated portion 72 has a radius that is 10 μm or less, or 6 μm or less, or is from greater than 0 μm to 10 μm, or from greater than 0 μm to 6 μm, or from 1 μm to 10 μm, or from 1 μm to 6 μm, or from 2 μm to 8 μm, or from 3 μm to 6 μm. Not wishing to be bound by any particular theory, it is believed that a smaller radius minimizes stagnant flow through the channels of flow 58a, 58b and minimizes the size of the no flow dead space 60.

As shown in FIG. 6, the expansion channel 54 has a length (L_{E}). The inlet channel 52 has a length that is equal to the length to taper (L_{F}) of the filter pillar 56. The combined lengths of the expansion channel 54 and the inlet channel 52 is shown as the fluid channel length (L_{C}) in FIG. 6. In other words, L_{C}=L_{E}+L_{F}. The overall length (OL_{F}) of the filter pillar 56 is less than the fluid channel length (L_{C}). In other words, OL_{F}<L_{C}.

The expansion channel 54 has an overall width (W_{E}) and each inlet channel 52 has an inlet width (W_{I}). The filter pillar 56 has a width (W_{F}). The combined widths of the inlet widths (W_{I}) and filter pillar 56 width (W_{F}) are equal to the overall width (W_{E}) of the expansion channel. In other words, in the modified fluid ejection head 50 shown in FIG. 6, which has two inlet channels 52, W_{E}=(2*W_{I})+W_{F}.

In an embodiment, the filter pillar 56 has a length to taper (L_{F}) of about 10 to about 15 μm, or from 10 to 15 μm, and an overall length (OL_{F}) ranging from about 25 to about 30 μm, or from 25 to 30 μm. It is understood that the difference between the OL_{F} and the L_{F} is the length of the elongated portion 72 of the filter pillar 56. In other words, OL_{F}−L_{F}=the length of the elongated portion 72.

In an embodiment, there is one nozzle hole 70 for each fluid chamber 66, and one nozzle hole 70 for each fluid ejector 68. In other words, the ratio of nozzle holes to fluid chambers to fluid ejectors is 1:1:1.

In an embodiment, there is one filter pillar 56 for each nozzle hole 70, one nozzle hole 70 for each fluid chamber 66, and one nozzle hole 70 for each fluid ejector 68. In other words, the ratio of filter pillars to nozzle holes to fluid chambers to fluid ejectors is 1:1:1:1.

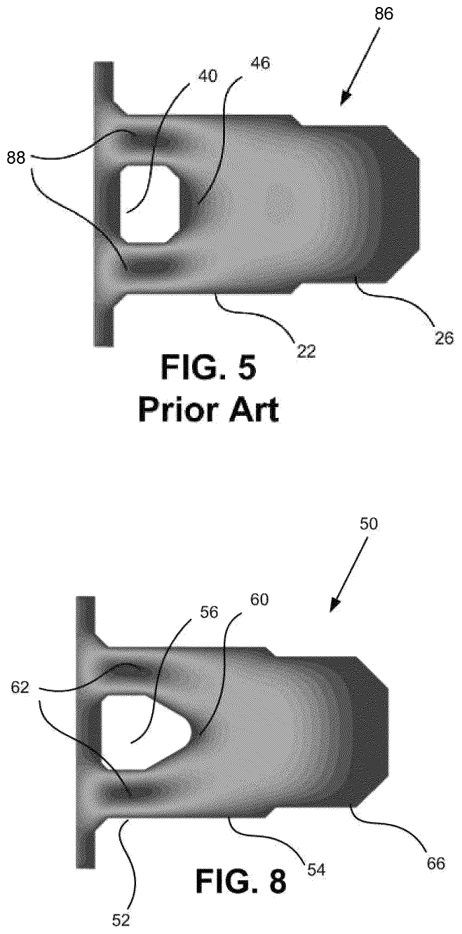

Not wishing to be bound by any particular theory, it is believed that the blunt filter pillars 40 cause the refill fluid 88 to have a flow pattern that may cause a low flow or no-flow region 46 between the blunt filter pillar 40 and the fluid chamber 26, as shown in FIG. 5. FIG. 5 is a color-coded illustration of the fluid flow pattern during fluid refill of the fluid chambers 26 of the modified prior art fluid ejection head 86, wherein the reddish colors represent fluid flow rates in the fluid channel 22 and the bluish colors represent low flow or no flow regions 46 of the fluid channel 22. As shown in FIG. 5, the modified prior art fluid ejection head 86 having a blunt filter pillar 40 has parabolic fluid flow profile with a maximum velocity at the centers of the fluid channels 22. The low flow or no flow region 46 tends to trap air that has been ingested into the ejection head when the meniscus is deformed in the nozzle hole 20 during the fluid chamber refilling step.

Like the modified prior art fluid ejection head 86, the modified fluid ejection head 50 includes the inlet channel 52 that provides refill fluid 62 from the fluid supply via 64 to refill the fluid chamber 66 after activating the fluid ejector 68 that causes the fluid 62 to be expelled through the nozzle hole 70.

FIG. 8 is a color-coded illustration of the fluid flow pattern during fluid refill of the fluid chambers 66 of the modified fluid ejection head 50, wherein the reddish colors represent fluid flow rates in the fluid channels 52, 54 and the bluish colors represent low flow or no flow regions 60 of the fluid channels 52, 54. As shown in FIG. 8, the modified ejection head 50 having a tapered filter pillar 56 has a parabolic fluid flow profile within the fluid channels 52 and 54, similar to the fluid flow pattern of the modified prior art fluid ejection head 86 containing a blunt filter pillar 40 shown in FIG. 5. However, the low flow or no flow region 60 of the modified ejection head 50 having a tapered filter pillar 56 is greatly reduced compared to the low flow or no flow region 46 of the modified prior art fluid ejection head 86 with the blunt filter pillar 40. Accordingly, the amount of air trapped in the modified fluid ejection head 50 is also reduced, providing a significant improvement in fluid droplet quality and stability relative to modified prior art fluid ejection head 86. As a result of the lower fluid flow rate near the centerline of the fluid chambers 66 in the modified fluid ejection head 50 and the reduction in air ingestion, the choke damping may be reduced, resulting in a higher frequency response of the modified fluid ejection head 50.

Additionally, the inlet channel 52 and the expansion channel 54 of the modified ejection head 50 have an impact on the fluid velocity during refill of the fluid chamber 66. The overall width of the expansion channel (W_{E}) is selected based on the viscosity of the fluid in order to reduce flow resistance during the fluid refill step of the fluid ejection head 50 and to reduce the possibility of trapping air in the fluid chamber 66. There is also a practical limit of the expansion channel length (L_{E}) since the Reynolds number of the fluid decreases as the fluid expands in the expansion channel 54.

For a wide range of viscosity control, a ratio of the expansion channel width (W_{E}) to inlet channel width (W_{E}/W_{I}) should be about 3 to about 4 to provide an ideal expansion angle of fluid in the inlet channel 52 and expansion channel 54. Lower ratios provide less regulation of high viscosity fluids since the flow expansion is limited. Ratios higher than 5 may be less practical as the additional expansion channel width will not significantly reduce the flow resistance for the higher viscosity fluids.

The W_{E}/W_{I} ratio may also be used to define the expansion channel length (L_{E}). For example, if designing for a maximum expansion angle of 12 of 30 degrees, the expansion channel length (L_{E}) can be calculated as follows:

$${L}_{E} = ( ( {W}_{E} / {W}_{I} ) - 1 ) / 2 * ( {W}_{I} ) * 1 / tan ( 30 ) .$$

Accordingly, the expansion channel length (L_{E}) to inlet width (W_{I}) ratio (L_{E}/W_{I}) is determined as follows:

$${L}_{E} / {W}_{I} = ( ( {W}_{E} / {W}_{I} ) - 1 ) / ( 2 * tan ( 30 ) ) .$$

The following Table 1 shows the calculated expansion channel length to inlet channel width ratios (L_{E}/W_{I}) as a function of the ratios of expansion channel width to inlet channel width (W_{E}/W_{I}) for the example of a maximum expansion angle of 30 degrees.

TABLE 1

| W_{E}/W_{I} | L_{E}/W_{I} |
|---|---|
| 3 | 1.73 |
| 4 | 2.60 |
| 5 | 3.46 |

The width of the expansion channel (W_{E}) can be modified as needed for a particular application. For example, if high viscosity fluids are not used, then the width of the expansion channel (W_{E}) can be reduced while maintaining the expansion channel length (L_{E}). For typical applications, the following ratios may be used as a general rule:

$${W}_{E} / {W}_{I} > 1.5 and$$

$${L}_{E} / {W}_{I} > 1.5 .$$

It is believed that fluid ejection heads 50 designed according to the embodiments described herein may be suitable for a wider variety of fluids so that the viscosity of the fluids will have less of an effect on the fluid refill times than with prior art ejection heads. For all of the embodiments disclosed herein, the thickness of the flow feature layer is not critical to improving the fluid refill times for the fluid ejection head.

Fluid to be ejected by the modified fluid ejection head 50 is provided through the fluid supply via 64 from a fluid filled cartridge 28 (FIG. 2) to which the modified fluid ejection head 50 is attached. Control of fluid ejection is provided by a fluid dispensing device 30 (FIG. 3) to which the fluid filled cartridge 28 is attached. The fluid dispensing device 30 may be a printer or other fluid deposition device that may be used to eject a variety of aqueous and/or non-aqueous fluids having a range of fluid viscosities.

In an embodiment, a fluid ejection head 50 is provided. The fluid ejection head 50 may be any modified fluid ejection head 50 disclosed herein. In an embodiment, the fluid ejection head 50 includes (A) a semiconductor substrate 12 containing a plurality of fluid ejectors 68 thereon and a fluid supply via 64 etched therethrough; (B) a flow feature layer 16 attached to the semiconductor substrate 12, the flow feature layer 16 having a plurality of fluid channels and fluid chambers 66 for the plurality of fluid ejectors 68, wherein the plurality of fluid channels are configured to provide fluid from the fluid supply via 64 through the plurality of fluid channels to the fluid chambers 66 for ejection of fluid through fluid nozzles 70 associated with the fluid chambers 66, and wherein each of the plurality of fluid channels includes an inlet channel 52 and expansion channel 54; (C) a filter pillar 56 in each inlet channel 52, each filter pillar 56 having a taper angle 74 ranging from about 25 to about 35 degrees relative to planes 76 defined by parallel sides 78 of the filter pillar 56; and (D) a nozzle plate 18 containing the fluid nozzles 70 attached to the flow feature layer 16. In some embodiments, the fluid ejection head 50 has one, some, or all of the following properties:
a) the filter pillar 56 has a taper angle 74 of from 25 to 35 degrees, or of about 30 degrees, or of 30 degrees relative to planes 76 defined by parallel sides 78 of the filter pillar 56; and/or
b) the expansion channels 54 are disposed between each of the inlet channels 52 and associated fluid chambers 66; and/or
c) the expansion channels 54 have an expansion channel width (W_{E}) to inlet channel width (W_{I}) ratio (W_{E}/W_{I}) ranging from about 3 to about 4, or from 3 to 4; and/or
d) the expansion channels 54 have an expansion channel length (L_{E})=((W_{E}/W_{I})−1)/2*W_{I}*1/tan(30), wherein L_{E}/W_{I}=((W_{E}/W_{I})−1)/(2*1/tan(30)); and/or
e) L_{E}/W_{I} is greater than 1.5, or ranges from about 1.5 to about 4.0, or from 1.5 to 4.0; and/or
f) W_{E}/W_{I} is greater than 1.5 and L_{E}/W_{I} is greater than 1.5; and/or
g) W_{E}=(2*W_{I})+W_{F}; and/or
h) OL_{F}<L_{C}; and/or
i) the fluid nozzles 70 have a diameter ranging from about 30 to about 40 μm, or from 30 to 40 μm; and/or
j) the fluid ejection head 50 is configured to dispense fluid droplets having a size ranging from about 30 to about 60 pL, or from 30 to 60 pL, or from about 45 to about 55 pL, or from 45 to 55 pL; and/or
k) the filter pillar 56 has a width (W_{F}) ranging from about 20 to 25 μm, or from 20 to 25 μm; and/or
l) the filter pillar 56 has a length to taper (L_{F}) of about 10 to about 15 μm, or from 10 to 15 μm; and/or
m) the filter pillar 56 has an overall length (OL_{F}) ranging from about 25 to about 30 μm, or from 25 to 30 μm; and/or
n) the filter pillar 56 has a length to taper (L_{F}) of about 10 to about 15 μm, or from 10 to 15 μm and an overall length (OL_{F}) ranging from about 25 to about 30 μm, or from 25 to 30 μm; and/or
o) the height of the filter pillar 56 is the same as the height of the fluid channels 58a and 58b; and/or
p) the height of the filter pillar 56 ranges from about 25 to about 35 μm, or 25 to 35 μm; and/or
q) the parallel sides 78 of the filter pillar 56 have a proximal end and a distal end, the distal end terminates at the elongated portion 72 of the filter pillar 56; and/or
r) one side of the filter pillar 56 connects the proximal ends of each of the parallel sides 78, said one side extending perpendicular to each of the parallel sides 78; and/or
s) the elongated portion 72 of the filter pillar 56 is formed from two conjoining sides that begin at the distal end of a parallel side 78 and extend at the angle 74 towards one another to terminate at an intersection point; and/or
t) the elongated portion 72 has a triangular, or a substantially triangular cross-sectional shape; and/or
u) the intersection point of the two sides that form the elongated portion 72 has a radius that is 10 μm or less, or 6 μm or less, or is from greater than 0 μm to 10 μm, or from greater than 0 μm to 6 μm, or from 1 μm to 10 μm, or from 1 μm to 6 μm, or from 2 μm to 8 μm, or from 3 μm to 6 μm; and/or
v) the flow feature layer 16 has a thickness ranging from about 5 to about 50 μm, or from 5 to 50 μm; and/or
w) the semiconductor substrate 12 is a silicon semiconductor substrate containing the plurality of fluid ejectors 68 formed thereon; and/or
x) the fluid ejectors 68 are selected from piezoelectric devices or heater resistors formed on the semiconductor substrate 12; and/or
y) the nozzle plate 18 has a thickness ranging from about 5 to about 50 μm, or from 5 to 50 μm; and/or
z) there is one nozzle hole 70 for each fluid chamber 66, and one nozzle hole 70 for each fluid ejector 68; and/or
aa) there is one filter pillar 56 for each nozzle hole 70, one nozzle hole 70 for each fluid chamber 66, and one nozzle hole 70 for each fluid ejector 68.

In some embodiments, a fluid dispensing device 30 is provided. The fluid dispensing device 30 contains a fluid cartridge 28 having fluid to be dispensed by the fluid ejection head 50. The fluid ejection head 50 may be any modified fluid ejection head 50 disclosed herein.

In an embodiment, a method is provided for reducing the air entrapment in a fluid ejection head 50. The method includes (A) providing a semiconductor substrate 12 containing a plurality of fluid ejectors 68 thereon and a fluid supply via 64 etched therethrough; (B) attaching a flow feature layer 16 to the semiconductor substrate 12, wherein the flow feature layer 16 includes a plurality of fluid channels and fluid chambers 66 for the plurality of fluid ejectors 68, wherein the plurality of fluid channels 66 are configured to provide fluid from the fluid supply via 64 through the fluid channels to the fluid chambers 66 for ejection of fluid through fluid nozzles 70 associated with the fluid chambers 66; (D) forming inlet channels 52 and expansion channels 54 between the fluid supply via 64 and each of the fluid chambers 66 of the flow feature layer 16; (E) forming a filter pillar 56 in each of the inlet channels 52, wherein each of filter pillar 56 has a taper angle 74 ranging from about 25 to about 35 degrees relative to planes 76 defined by parallel sides 78 of the filter pillar 56; (F) attaching a nozzle plate 18 to the flow feature layer 16; (G) feeding fluid from a fluid cartridge 28 to the fluid ejection head 50; and (H) ejecting fluid from the fluid ejection head 50. The fluid ejection head 50 may be any modified fluid ejection head 50 disclosed herein.

In an embodiment, a fluid dispensing device 30 for ejecting an aqueous fluid having a viscosity ranging from about 2 to about 5 millipascal second at 23° C., or from 2 to 5 millipascal second at 23° C., is provided. The fluid dispensing device 30 includes a fluid ejection head 50 attached to a fluid supply cartridge 28 containing the fluid. The fluid ejection head 50 may be any modified fluid ejection head 50 disclosed herein. In an embodiment, the fluid ejection head 50 includes (A) a semiconductor substrate 12 containing a plurality of fluid ejectors 68 thereon and a fluid supply via 64 etched therethrough; (B) a flow feature layer 16 attached to the semiconductor substrate 12, wherein the flow feature layer 16 includes a plurality of fluid channels and fluid chambers 66 for the plurality of fluid ejectors 68, wherein the fluid channels are configured to provide the fluid from the fluid supply via 64 through the fluid channels to the fluid chambers 66 for ejection of the fluid through fluid nozzles 70 associated with the fluid chambers 66, and wherein the fluid channels include inlet channels 52 and expansion channels 54; (C) a filter pillar 56 in each inlet channel 52 having a taper angle 74 ranging from about 25 to about 35 degrees relative to planes 76 defined by parallel sides 78 of the filter pillar 56; and (D) a nozzle plate 18 containing the fluid nozzles 70 attached to the flow feature layer 16. The expansion channels 54 have an expansion channel width (W_{E}) to inlet channel width (W_{I}) ratio (W_{E}/W_{I}) ranging from about 3 to about 4, or from 3 to 4.

The fluid ejection head 50 may comprise two or more embodiments disclosed herein.

In order to further illustrate the benefits of the modified fluid ejection head 50 of the disclosed embodiments, the following non-limiting example is presented.

### Example

A comparison of ink jet print results of modified prior art fluid ejection head with blunt filter pillars (FIG. 5) compared to an ejection head with tapered filter pillars (FIG. 6) using a low viscosity aqueous ink illustrates the advantages of the tapered filter pillar 56. FIG. 9 illustrates print results with a modified prior art fluid ejection head 86 with a blunt filter pillar 40, wherein the sharpness of the vertical lines 86 is distorted by significant air entrainment in the modified prior art fluid ejection head 86. The sharpness of the vertical lines 88 of the print results shown in FIG. 10 using the modified print head 50 is an indication that the modified ejection head has minimized air trapping.

As illustrated by the foregoing example, there are significant, unexpected advantages of the modified fluid ejection head 50 having tapered filter pillars 56. The modified fluid ejection head 50 exhibits both reduced air ingestion and reduced air trapping allowing higher frequency fluid ejection operation. The improved fluid ejection head design has been found to be especially beneficial for extending the performance of larger droplet fluid ejection heads.

Having described various aspects and exemplary embodiments and several advantages thereof, it will be recognized by those of ordinary skills that the disclosed embodiments is susceptible to various modifications, substitutions and revisions within the spirit and scope of the appended claims.

What is claimed is:

1. A fluid ejection head comprising:
a semiconductor substrate containing a plurality of fluid ejectors thereon and a fluid supply via etched therethrough;
a flow feature layer attached to the semiconductor substrate, wherein the flow feature layer comprises a plurality of fluid channels and fluid chambers for the plurality of fluid ejectors, wherein the plurality of fluid channels are configured to provide fluid from the fluid supply via through the plurality of fluid channels to the fluid chambers for ejection of fluid through fluid nozzles associated with the fluid chambers, and wherein each of the plurality of fluid channels comprise an inlet channel and expansion channel;
a filter pillar in each inlet channel, each filter pillar having a taper angle ranging from about 25 to about 35 degrees relative to planes defined by parallel sides of the filter pillar; and
a nozzle plate containing the fluid nozzles attached to the flow feature layer.

2. The fluid ejection head of claim 1, wherein the filter pillar has a taper angle of about 30 degrees relative to planes defined by parallel sides of the filter pillar.

3. The fluid ejection head of claim 1, wherein the expansion channels are disposed between each of the inlet channels and associated fluid chambers.

4. The fluid ejection head of claim 1, wherein the expansion channels have an expansion channel width (W_{E}) to inlet channel width (W_{I}) ratio (W_{E}/W_{I}) ranging from about 3 to about 4.

5. The fluid ejection head of claim 4, wherein the expansion channels have an expansion channel length (L_{E})=((W_{E}/W_{I})−1)/2*W_{I}*1/tan(30), wherein L_{E}/W_{I}=((W_{E}/W_{I})−1)/(2*1/tan(30)).

6. The fluid ejection head of claim 5, wherein L_{E}/W_{I} ranges from about 1.5 to about 4.0.

7. The fluid ejection head of claim 6, wherein W_{E}/W_{I} is greater than 1.5 and wherein L_{E}/W_{I} is greater than 1.5.

8. A fluid dispensing device comprising a fluid cartridge having fluid to be dispensed by the fluid ejection head of claim 1.

9. A method for reducing the air entrapment in a fluid ejection head comprising:
providing a semiconductor substrate containing a plurality of fluid ejectors thereon and a fluid supply via etched therethrough;
attaching a flow feature layer to the semiconductor substrate, wherein the flow feature layer comprises a plurality of fluid channels and fluid chambers for the plurality of fluid ejectors, wherein the plurality of fluid channels are configured to provide fluid from the fluid supply via through the fluid channels to the fluid chambers for ejection of fluid through fluid nozzles associated with the fluid chambers; and
forming inlet channels and expansion channels between the fluid supply via and each of the fluid chambers of the flow feature layer;
forming a filter pillar in each of the inlet channels, wherein each of filter pillar has a taper angle ranging from about 25 to about 35 degrees relative to planes defined by parallel sides of the filter pillar; and
attaching a nozzle plate to the flow feature layer;
feeding fluid from a fluid cartridge to the fluid ejection head; and
ejecting fluid from the fluid ejection head.

10. The method of claim 9, wherein the filter pillar has a taper angle of about 30 degrees relative to planes defined by parallel sides of the filter pillar.

11. The method of claim 9, wherein the expansion channels have an expansion channel width (W_{E}) to inlet channel width (W_{I}) ratio (W_{E}/W_{I}) ranging from about 3 to about 4.

12. The method of claim 11, wherein the expansion channels have an expansion channel length (L_{E})=((W_{E}/W_{I})−1)/2*W_{I}*1/tan(30), wherein L_{E}/W_{I}=((W_{E}/W_{I})−1)/(2*1/tan(30)).

13. The method of claim 12, wherein L_{E}/W_{I} ranges from about 1.5 to about 4.0.

14. The method of claim 9, wherein the fluid ejection head is configured to reduce fluid velocity at a centerline of the fluid chambers.

15. A fluid dispensing device for ejecting an aqueous fluid having a viscosity ranging from about 2 to about 5 millipascal second at 23° C., the fluid dispensing device comprising:
a fluid ejection head attached to a fluid supply cartridge containing the fluid, wherein the fluid ejection head comprises:
a semiconductor substrate containing a plurality of fluid ejectors thereon and a fluid supply via etched therethrough;
a flow feature layer attached to the semiconductor substrate, wherein the flow feature layer comprises a plurality of fluid channels and fluid chambers for the plurality of fluid ejectors, wherein the fluid channels are configured to provide the fluid from the fluid supply via through the fluid channels to the fluid chambers for ejection of the fluid through fluid nozzles associated with the fluid chambers, and wherein the fluid channels comprise inlet channels and expansion channels;
a filter pillar in each inlet channel having a taper angle ranging from about 25 to about 35 degrees relative to planes defined by parallel sides of the filter pillar; and
a nozzle plate containing the fluid nozzles attached to the flow feature layer,
wherein the expansion channels have an expansion channel width (W_{E}) to inlet channel width (W_{I}) ratio (W_{E}/W_{I}) ranging from about 3 to about 4.

16. The fluid dispensing device of claim 15, wherein the filter pillar has a taper angle of about 30 degrees relative to planes defined by parallel sides of the filter pillar.

17. The fluid dispensing device of claim 15, wherein the expansion channels have an expansion channel length (L_{E})=((W_{E}/W_{I})−1)/2*W_{I}*1/tan(30), wherein L_{E}/W_{I}=((W_{E}/W_{I})−1)/(2*1/tan(30)).

18. The fluid dispensing device of claim 17, wherein L_{E}/W_{I} ranges from about 1.5 to about 4.0.
